(19) United States
(12) Patent Application Publication
(10) Pub. No.: US 2004/0008683 A1
(43) Pub. Date: Jan. 15, 2004

(54) Method and system for improving bandwidth utilization when supporting mixes of DOCSIS 2.0 and DOCSIS 1.x cable modems

(76) Inventors: Thomas J. Cloonan, Lisle, IL (US); Steven J. Krapp, Naperville, IL (US)

Correspondence Address: ARRIS INTERNATIONAL, INC, 11450 TECHNOLOGY CIRCLE, DULUTH, GA, 30097, US

(21) Appl. No.: 10/447,804

(22) Filed: May 29, 2003

Related U.S. Application Data
(60) Provisional application No. 60/384,048, filed on May 29, 2002.

(51) Int. Cl. H04L 12/28; H04L 12/56

(52) U.S. Cl. 370/395.4; 370/468

(57) ABSTRACT

A high level MAP scheduler directs upstream traffic from fiber nodes by controlling low-level MAP schedulers based on spectrum overlap of corresponding physical channels. Of the physical channels controlled by the high level scheduler, one may be configured for high-bandwidth transmission and others for low-bandwidth traffic. Thus, upstream traffic from multiple cable modems not being transmitted in a wide bandwidth spectrum can simultaneously share bandwidth within a physical channel that is capable of high bandwidth traffic, as long the spectrum used for one does not overlap spectrum used by another. This ability also enables instantaneous switching between high and low bandwidth modes without burst interval loss because each physical channel corresponds to a dedicated PHY receiver. Instead of reconfiguring a PHY for a different mode, one PHY can stop accepting upstream traffic while one configured for a different mode simultaneously starts.

### CROSS REFERENCE TO RELATED APPLICATION

This application claims the benefit of priority under 35 U.S.C. 119(e) to the filing date of Cloonan, et al., U.S. provisional patent application No. 60/384,048 entitled “Method and System for Improving Bandwidth Utilization when Supporting Mixes of Docsis 2.0 and Docsis 1.X Cable Modems”, which was filed May 29, 2002, and is incorporated herein by reference in its entirety.

### FIELD OF THE INVENTION

The present invention relates to network communication systems. More specifically, the present invention relates to efficiently using the bandwidth available in a physical communication channel that can accommodate DOCSIS 2.0 communication.

### BACKGROUND

For improving data delivery, designers of version 2.0 of the Data Over Cable Service Interface Specification (“DOCSIS”) created a new specification in response to the growing demand for more upstream data bandwidth using a community antenna television (“CATV”) system. Such demand has emerged as usage of peer-to-peer applications (such as interactive gaming, MP3 file exchanges, voice over IP telephony, etc.) and business-to-business applications (such as T1 replacements) has appeared over hybrid fiber coaxial (“HFC”) networks. These emerging applications demand a more symmetrical transport of data than asymmetrical applications, such as, for example, Web surfing, that has dominated Internet usage in the past. In addition, upstream noise, HFC plant impairments, and many legacy service offerings (such as previously-installed proprietary data services, set-top box transmissions, CBR Cable Telephony services, etc.) consume much of the available upstream bandwidth on the cable To accommodate these upstream bandwidth demands, the DOCSIS 2.0 specification focused on the upstream PHY and MAC layer protocols in an attempt to augment the existing specification with new and improved, although more complicated, modulation techniques. DOCSIS 2.0 goals included, but are not limited to:

remain backwards compatible with DOCSIS b 1.0 and DOCSIS 1.1—collectively referred to herein as DOCSIS 1.x, although 1.x may also comprise higher versions than 1.1;

provide the ability to support more symmetrical data transport;

increase capacity in each upstream channel;

increase the spectral efficiency (bps/Hz) of the upstream spectrum;

provide for more noise immunity within the upstream channels; and

correct any problems/oversights found in the DOCSIS 1.1 specification

As a result, multiple system operators (“MSOs”) will be able to provide more upstream bandwidth per customer or support more customers per upstream channel.

Two new modulation techniques in DOCSIS 2.0 supplement the time division multiple access (“TDMA”) upstream modulation technique used for DOCSIS 1.0 and DOCSIS 1.1. Cable modem termination system (“CMTS”) operating under DOCSIS 2.0 must support these new modulation techniques, known as Advanced Time-Division Multiple Access (“ATDMA”) and Synchronous Code-Division Multiple Access (“SCDMA”), in addition to TDMA.

While TDMA and ATDMA have similarities with one another, they are different from SCDMA. An analogy can be drawn between these technologies and common communication forums. For example, it will be shown that TDMA/ATDMA are similar to the communication forum used in conference presentations. In particular, each speaker takes control of the podium for a specific period of time, and they must speak rapidly to communicate their information before relinquishing the podium to the next speaker (who must repeat the process).

SCDMA, on the other hand, is similar to a party where many conversations are occurring in parallel, but the speaker and listener of each conversation are only “tuned in” to their discrete information exchange. The other conversations merely create background noise, so each of the speakers at the party talks slowly so that they can be clearly heard. To make the analogy even more correct, assume that each of the many conversations at the party is being spoken in a different language so that the other conversations are not even understood by the two people in a particular conversation.

As their names would imply, both TDMA and ATDMA are time-division multiple access technologies that permit multiple users, —i.e. cable modems (“CMs”) at subscribers' premises—to share the bandwidth within an upstream channel by allowing each of the users to transmit by themselves within a unique burst interval, or time slot. Thus, TDMA and ATDMA transmissions use the bandwidth in a manner similar to the way in which speakers share the podium in a conference—one speaker at a time. In both the TDMA and the ATMDA case, burst intervals can be variable in length. The temporal sequencing of consecutive burst intervals can be applied to the ATDMA space as well as the TDMA space.

Whereas the DOCSIS 2.0 ATDMA scheme and the DOCSIS 1.x TDMA scheme are somewhat similar in basic structure and operation, the DOCSIS 2.0 Synchronous Code-Division Multiple Access (SCDMA) scheme is a member of an entirely different genre of transmission techniques. As previously discussed, SCDMA uses the bandwidth in a manner similar to the way in which people at a party can have many different parallel conversations in different languages and not interfere with one another. SCDMA transmission has been described as a “spread-spectrum” technology or a “spread-time” technology. Neither of these terms truly describes the clever set of tricks that are used in SCDMA. Accordingly, the foregoing will discuss how SCDMA operates at a rudimentary level.

As a starting point, consider a baseline 3.2 MHz-wide upstream channel that is capable of transporting a DOCSIS 1.x TDMA signal using 16QAM, which is known in the art. Using TDMA technology, a single cable modem can transmit in the upstream channel in a given burst interval. The transmission produces a sequential stream of 16QAM symbols, and each symbol has a period of 390.625 nsec. The permitted symbol rate in the channel is 2.56 Msymbol/sec, and the resulting bit-rate (with four bits per symbol) is 10.24 Mbps.

Now assume that the same 3.2 MHz-wide channel is used to transmit a stream of 16QAM symbols using SCDMA transmission instead of TDMA transmission. From a high-level point-of-view, SCDMA modifies the original symbol-stream using two clever tricks. The first trick is known as symbol spreading. Symbol spreading requires that each symbol be stretched (or spread) in time by a factor of 128, so a single spread symbol would have a period of (390.625 nsec)×(128)=50 μsec. The permitted symbol rate for this single SCDMA symbol stream in the channel is 20 ksymbol/sec, and the resulting bit-rate (with four bits per symbol) is 80 kbps (which is 1/128^{th} of the bit-rate for the TDMA symbol stream carried in the same 3.2 MHz-wide channel).

The longer symbol period in SCDMA transmission is known as the “spreading interval.” Using Fourier analysis techniques, it can be shown that these spread symbols consume only 1/128^{th} of the spectral bandwidth that is used by the shorter-period TDMA symbols.

The second clever trick used by SCDMA is to re-use the entire spectrum within the channel (since the spectral bandwidth of the spread symbol is only 1/128^{th} of the spectrum in the original TDMA signal). SCDMA accomplishes this by multiplying each spread symbol by a spreading code containing a unique string of 128 code symbols. Each code symbol must be assigned either a +1 value or a −1 value, and these code symbols are typically called “chips.” Since 128 code symbols (or chips) must fill the entire 50 μsec spreading interval, the chip duration is (50 μsec)/128=390.625 nsec. It is important to note that the SCDMA chip duration is identical to the period of the symbols used in the original TDMA case, so the resulting SCDMA chip rate is identical to the original TDMA symbol rate. Fourier analysis techniques have shown that the bandwidth utilized by the stream of SCDMA-encoded spread symbols is practically the same as the bandwidth utilized by the original TDMA symbol stream.

The receiver (de-spreader) for an SCDMA transmission system is actually a matched filter or correlator that correlates the received data stream with the spreading code associated with the desired transmitter. There are many different spreading codes (combinations of +1 and −1 chips) that can be specified. If a particular sequence of +1 and −1 chips associated with one spreading code are used to fill the elements of a column vector x and if a different sequence of +1 and −1 chips associated with a second spreading code are used to fill the elements of a second column vector y, then, employing a simple concept from linear algebra, the two vectors are said to be orthogonal if the inner product of the two vectors is zero (x^{T}y=0).

The selection of orthogonal spreading codes provides a benefit, because symbol streams from many different sources (cable modems) can be SCDMA-encoded using different spreading codes and they can then be combined on the same upstream channel. It can be shown that any one of the source symbol streams can be recovered from the resulting aggregated mix of symbol streams if the spreading codes from each source are orthogonal to one another. The receiver at the CMTS can “tune” to a symbol stream from a particular source using the unique spreading code associated with that particular source. The recovery of a particular symbol stream from the aggregated mix of symbol streams is accomplished by multiplying the aggregated mix of symbol streams by the unique spreading code associated with the source and summing the terms to produce a weighted version of the desired symbol stream at the receiver. This process is known as “de-spreading” the transmitted symbol stream, and it essentially calculates the inner product of the combined streams (Ax+By) and the spreading code for the desired source. For example, x would be used to de-spread symbols from source #1. The result of this inner product calculation is (Ax+BY)^{T}x=Ax^{T}x+By^{T}x=Ax^{T}x+0=A*|x|², which is a weighted version of the original spread symbol A.

It should be apparent that de-spreading works only if x and y are orthogonal. If the spreading codes from different transmitters are not phase aligned, then orthogonality between the spreading codes is sacrificed, and the recovery of the original spread symbols becomes prone to errors. Thus, the transmit clocks within the SCDMA sources (cable modems) must maintain a high degree of accuracy to maintain adequate chip-level phase alignment and modulator carrier phase alignment. This necessitates synchronous operation within SCDMA transmitters. The required SCDMA cable modem ranging accuracy must be approximately +/−0.01 of the nominal symbol period, which ensures that the spreading codes from different cable modems remain fairly well synchronized.

In DOCSIS 2.0 SCDMA operation, up to 128 simultaneous symbol streams (with different spreading codes) can be driven by many different cable modems. A burst from a single cable modem may be transmitted on two or more spreading codes within a frame, so up to 64 cable modems could be simultaneously transmitting in a frame. The CMTS mapping algorithm controls which combinations of cable modems are transmitting on a frame-by-frame basis. This mapping algorithm is responsible for changing the number of spreading codes assigned to each cable modem, and it can also change the frame size, so the algorithm can maintain tight control over the amount of bandwidth assigned to each cable modem. The intelligence within the mapping algorithm will ultimately determine the efficiency and fairness of the SCDMA transport scheme.

SCDMA provides many new techniques that will enable MSOs to operate upstream channels with higher throughputs. SCDMA can use all of the bandwidth improvement techniques defined for ATDMA. In addition, SCDMA may permit shorter preambles due to the use of synchronous transmission. SCDMA also offers another modulation format known as 128-point QAM or 128QAM. This format can only be enabled when a particular noise mitigation technique known as Trellis-Coded Modulation (TCM) is being used. 128QAM with TCM provides the same bit-rate performance as 64QAM without TCM.

While the DOCSIS 2.0 specification provides a simple mechanism for allowing DOCSIS 1.0, DOCSIS 1.1, and DOCSIS 2.0 cable modems and CMTSs to interoperate with one another, the co-existence of TDMA, ATDMA, and SCDMA is slightly more complicated. One serious complication in DOCSIS 2.0 arises from the fact that a CMTS operating with TDMA and ATDMA cable modems must specify time references when granting burst intervals to the cable modems, and the transmitting cable modem consumes the entire upstream channel during its burst interval, precluding the use of channel sharing during any particular burst interval. On the other hand, a CMTS operating with SCDMA cable modems must specify both time references and spreading codes when granting burst intervals to cable modems, and each transmitting cable modem can share the upstream channel with other cable modems during a frame. As a result of these differences, TDMA/ATDMA cable modems must not be transmitting during frames when SCDMA cable modems are transmitting, and SCDMA cable modems must not be transmitting during burst intervals when TDMA/ATDMA cable modems are transmitting. To simplify the coordination of the different types of transmission schemes when TDMA/ATDMA cable modems must share a single physical upstream channel with SCDMA cable modems, the DOCSIS 2.0 specification added a new concept known as a “logical channel.”

A single physical upstream channel can be sub-divided into multiple logical channels—at least one for TDMA/ATDMA and at least one other for SCDMA. Different physical channels can have different symbol rates and different center frequencies. Each physical channel has an upstream PHY receiver uniquely associated with it and each physical channel has a low level MAP scheduler associated with it that creates separate MAPs (sent in the downstream channel) for each of the logical channels defined within the physical channel. Within a single physical channel all defined logical channels share the same symbol rate and center frequency defined for the physical channel but the logical channels within a single physical channel can use different modulation modes (TDMA, ATDMA, or SCDMA) and different modulation types (QPSK, 8QAM, 16 QAM, 32QAM, 64 QAM, or 128QAM). Each logical channel is centered on the same center frequency, but each is essentially independent of the other, because each logical channel has its own set of MAPs and Upstream Channel Descriptors (UCDs). An example of time-interleaved TDMA/ATDMA frames and SCDMA frames from two different logical channels is illustrated in FIG. 1. The MAP scheduler within the CMTS is responsible for distributing idle periods so that two logical channels do not overlap with respect to time.

In current systems, a single physical downstream channel may typically be associated with several physical upstream channels. FIG. 2 illustrates a CMTS blade 2 used in a current system containing eight physical upstream channels received at upstream channel ports 4, the physical channels being associated with a single physical downstream channel 6. Each of the eight physical upstream channels 4 in the figure are further sub-divided into two logical channels, as shown by the double lines along the physical channel routes from fiber nodes 10 to optical receivers 12 at CMTS 14. As shown in the figure, each physical upstream channel 4 has a unique low-level MAP scheduler 8 associated with it that is responsible for scheduling the upstream burst intervals. Each low-level MAP scheduler 8 controls the burst intervals associated with both of the logical upstream channels within a single physical upstream channel 4. By organizing the control in this fashion, the MAP scheduler can prevent the two logical channels from overlapping with respect to time.

However, it will be appreciated that mixing a high-bandwidth logical channel with a low-bandwidth logical channel inside of the same physical channel results in inefficient utilization of the upstream spectrum. For example, the mix of a 6.4 MHz DOCSIS 2.0 logical channel with a 3.2 MHz DOCSIS 1.X logical channel is considered. Whenever the low-bandwidth 3.2 MHz channel is transmitting, half of the 6.4 MHz spectrum is unused as shown in FIG. 3. This may result in underutilization of bandwidth in a MSO's HFC plants. Thus, there is a need for a system that allows the full spectrum in an upstream channel to be utilized when 3.2 MHz data bursts are being sent upstream in a physical channel.

Another practical problem that is related to mixes of the new 6.4 MHz channels and the legacy 3.2 MHz channels is found in the fact that most DOCSIS 2.0 receiver chipsets cannot change their receiver functionality from the 6.4 MHz mode to the 3.2 MHz mode (or lower modes) very rapidly, if at all), or from the 3.2 MHz mode (or lower modes) to the 6.4 MHz mode very rapidly, if at all. If these receiver functionality mode changes are not supported while data is being transported, then the system operator cannot mix existing DOCSIS 1.x cable modem traffic and DOCSIS 2.0 cable modem traffic on the same physical upstream channel simultaneously if the DOCSIS 2.0 cable modems are operating in the 6.4 MHz mode.

If these receiver functionality mode changes are supported, but require an excessive amount of time to take place, then the system operator could waste a large number of burst opportunities on the physical channel when mixing existing DOCSIS 1.X cable modems and DOCSIS 2.0 cable modems on the same physical upstream channel when switching between modes to accommodate different burst types. In particular, if the DOCSIS 2.0 cable modems are operating on one logical channel using the 6.4 MHz mode and if the DOCSIS 1.X cable modems are operating on a second logical channel using the 3.2 MHz mode (or a lower mode), then during the transition between modes, no active burst intervals can be transmitted, as shown in the wasted burst opportunity intervals in FIG. 4. Thus, there is a need for a method and system for preventing waste of spectrum bandwidth while the CMTS transitions back and forth between the 6.4 MHz and the 3.2 MHz (or lower) mode for a given physical upstream channel.

### SUMMARY

The problems listed above indicate that the resulting configurations can still lead to inefficient utilization of upstream bandwidth and/or inefficient utilization of upstream burst opportunities. To solve these problems, the method and apparatus described within this paper implements a modification to the MAP Schedulers. In particular, it should be noted that the current implementations, such as those shown in FIG. 2, associate one MAP Scheduler to each of the upstream PHY receivers. Each of these MAP schedulers is responsible for creating the MAPs for each of the logical channels within the corresponding PHY receiver's physical upstream channel. The MAP scheduler ensures that no more than one logical channel is active at any moment in time. For purposes of discussion, these MAP Schedulers will be called “low-level MAP Schedulers.” Each low-level MAP Scheduler is only cognizant of the activity within its associated physical upstream channel.

An augmentation of this implementation allows more than one physical upstream channel to overlap on the same portion of the upstream spectrum on a shared common transmission link (this can be either an upstream fiber link or an upstream electrical conductor/wire, depending on where the signal is within the system) somewhere within the upstream data path. This augmentation adds a higher-level MAP Scheduler, which will be referred to as a “high-level MAP Scheduler.” This augmentation also adds splitting circuitry to steer multiple copies of the overlapping upstream spectra to different upstream PHY receivers. This differs from the systems known in the art, where typically one upstream PHY receiver is dedicated to each upstream physical channel.

The high-level MAP Scheduler is cognizant of the activity within more than one physical upstream channel. This high-level MAP Scheduler assigns usable time-periods to each of the low-level MAP Schedulers that are associated with the physical upstream channels that this particular high-level MAP Scheduler is entrusted to manage. The most important function of the high-level MAP Scheduler is to ensure that two physical upstream channels that overlap on the same portion of the upstream spectrum do not have active burst intervals that coincide in time. In particular, if one physical upstream channel is transmitting, then all of the other physical upstream channels that share upstream spectrum with the transmitting upstream channel remain idle, with idle periods defined by their MAPs. The high-level MAP Scheduler doles out time-periods to distribute bandwidth fairly among the physical upstream channels that share common spectrum. In order to do this, it can be given access to bandwidth requests associated with each of the physical upstream channels, current activity levels for subscribers on each of the physical upstream channels and service level agreements for subscribers on each of the physical upstream channels.

### BRIEF DESCRIPTION OF THE DRAWINGS

FIG. 1 illustrates a time-interleaved signal bursts of TDMA/ATDMA on logical channel A and SCDMA on logical channel B.

FIG. 2 illustrates a conventional CMTS blade having a MAP scheduler associated with each upstream physical channel.

FIG. 3 illustrates bandwidth utilization when an upstream logical channel having bandwidth of 3.2 MHz is centered within a physical channel capable of supporting a 6.4 MHz upstream channel.

FIG. 4 illustrates wasted burst opportunities when a CMTS switches between the transmission of upstream traffic in TDMA/ATDMA mode and ACDMA, each on separate logical channels within a single physical channel.

FIG. 5 illustrates a CMTS blade having a high level MAP scheduler controlling a plurality of low level MAP schedulers.

FIG. 6 illustrates the spectrum usage of a plurality of upstream logical channels spread across a plurality of upstream physical channels.

FIG. 7 illustrates the spectrum usage of two logical 3.2 MHz upstream channels transmitting traffic within a 6.4 MHz channel physical.

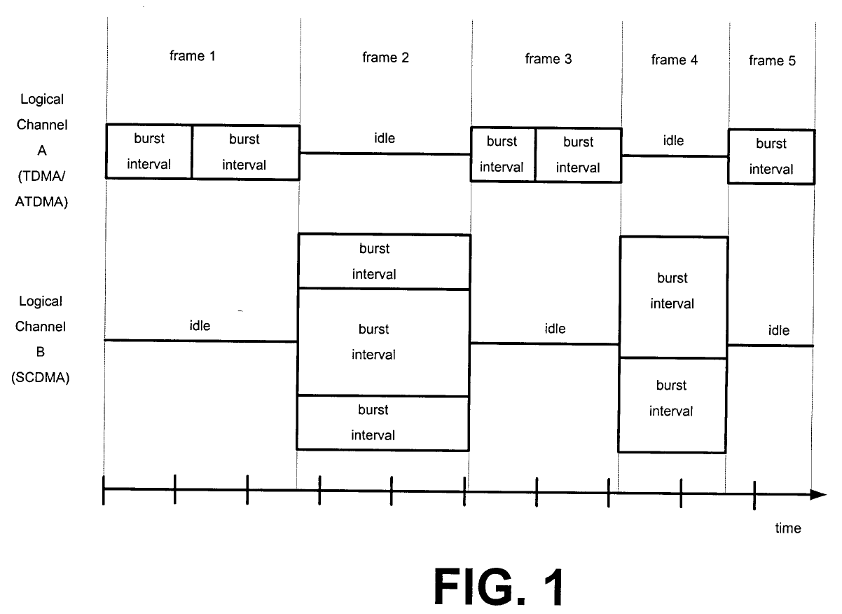

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude other embodiments, adaptations, variations, modifications and equivalent arrangements, the present invention being limited only by the claims appended hereto and the equivalents thereof.

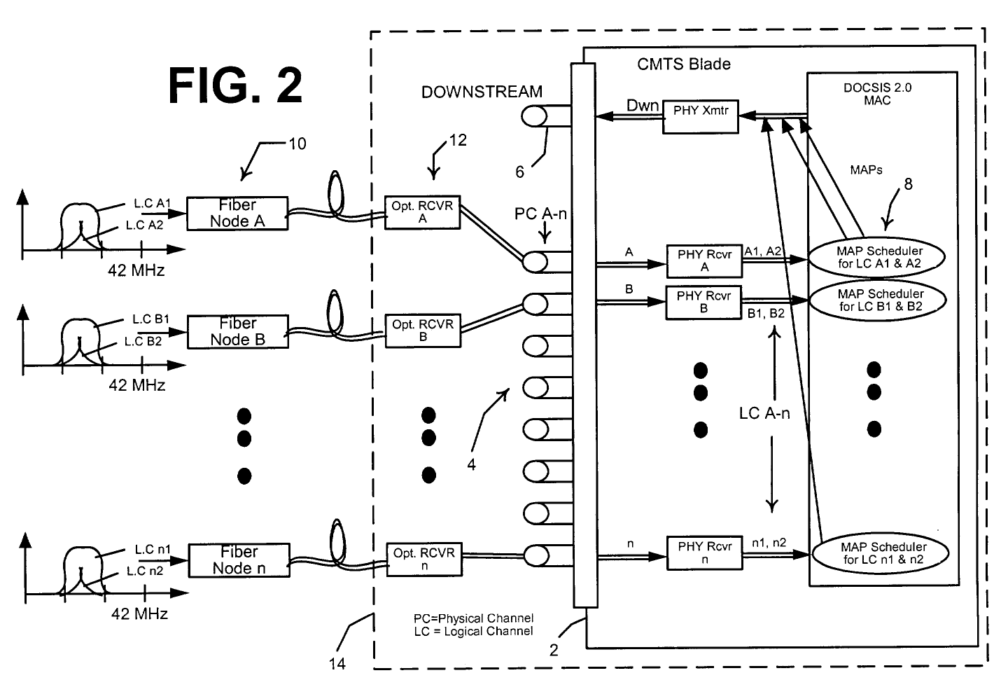

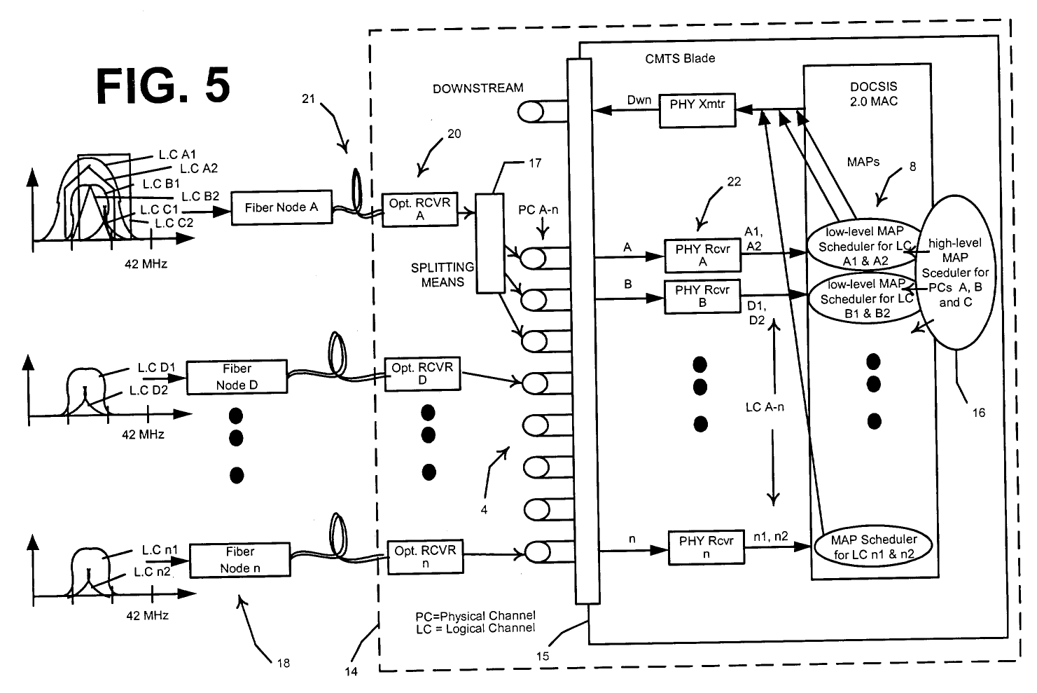

Turning now to FIG. 5, the figure illustrates a CMTS blade 15 similar to blade 2 shown in FIG. 2. However, the blade 15 shown in FIG. 5 includes a high-level MAP Scheduler 16 assigned to manage the low-level MAP Schedulers 8 corresponding to physical upstream channel ports 4A, 4B and 4C. In addition, splitting circuitry 17, known in the art (for example, three wires tied to the same electrical circuitry node on receiver 20A), is used to distribute output from optical receiver 20, which typically has one output, to the three different physical channel ports 4A, 4B and 4C.

It will be appreciated that typically three parameters define the characteristics of a physical channel. These three parameters include center frequency, channel width—or bandwidth—which is typically determined by the symbol rate of the traffic data being transmitted, and a PHY corresponding to the physical channel. A physical upstream channel conventionally transmits data within a single physical path, such as for example, an optical fiber or an electrical wire, or a combination of both. For purposes of discussion herein, a physical path comprises a node 18, a fiber link 21 and a corresponding optical receiver 20. A physical upstream channel path may connect to a single upstream channel port 4, or may be split such that a plurality of copies of the traffic transmitted along a given data path is provided to a corresponding plurality of ports 4 and respectively corresponding physical interface chips (“PHY”) 22. It will be appreciated that an individual physical path has conventionally been associated with a dedicated PHY as shown in FIG. 2, because multiple physical channels whose bandwidth spectrum is shared with, or at least overlaps that of, another physical channel, are not used in the same physical path.

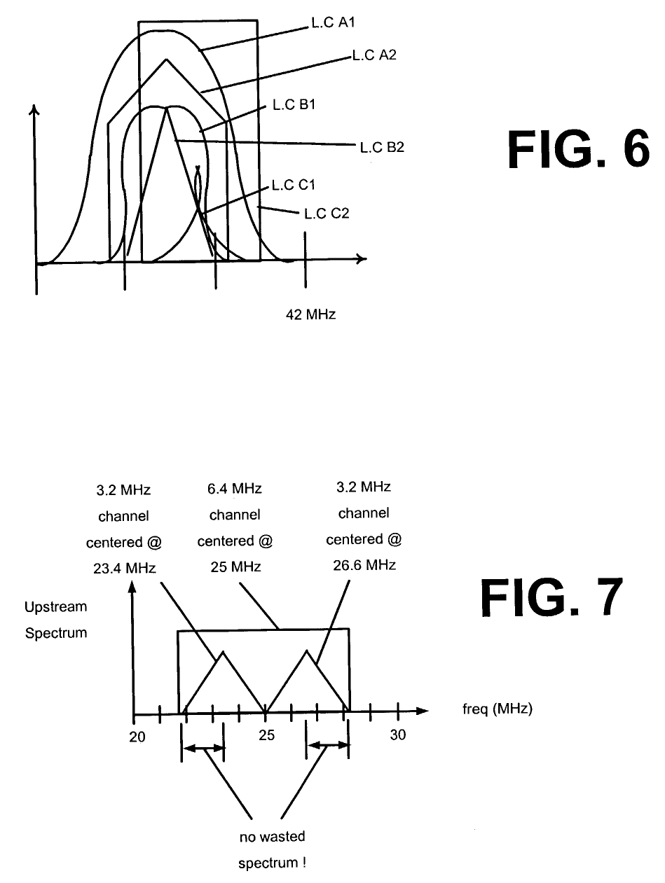

Since each of these physical upstream channels A, B and C support at least two logical upstream channels, the high-level MAP scheduler 16 actually manages six logical upstream channels (labeled A1, A2, B1, B2, C1, and C2). As shown in FIG. 5 and FIG. 6, these six logical upstream channels may all share a portion of the upstream spectrum and may all be transmitted upstream on the same physical fiber/wire path 21 A. The figure illustrates three physical channels that may be carried along the path 21A between node 18A and receiver 20A, and are split at splitter 17, which may contain active circuitry, or may be as simple as three electrical wires all connected to the electrical output of receiver 20A.

The plurality of spectrum portions, represented by the various shapes shown in FIG. 6 and used by the logical channels, are shown at the upstream inputs to the fiber nodes 18. For purposes of illustration, each logical channel is represented by a different bandwidth signature shape to the left of the 42 MHz physical channel center frequency. After determining the characteristics of all the channels having data to be sent upstream, the high-level MAP scheduler 16 uses this determined information to ensure that only one of the physical upstream channels A, B, or C that are attempting to transmit upstream using overlapping portions of spectrum along a single physical path will transmit simultaneously. Thus, the high-level MAP Scheduler 16 will dole out time-periods to each of the low-level MAP Schedulers based on spectrum usage. Accordingly, for example, if none of the three upstream physical channels is attempting to transmit in the same spectral space as the others, then all three can transmit traffic bursts simultaneously. It will be appreciated that in FIG. 5, the channel representations shown in FIG. 6 represent three physical channels that transmit in physical data path 21A between node 18A and receiver 20A. Thus, in the system shown in FIG. 5, there are no nodes or receivers corresponding to paths B or C, because there are no paths B or C and in the system shown in FIG. 2. However, there are still physical channels B and C that, along with physical channel A, are carried in physical path A, which comprises node 18A, receiver 20A and the fiber link 21 that connects them.

Furthermore, during a time period when the high-level MAP scheduler 16 has granted the use of the upstream spectrum to physical upstream channel A, the low-level MAP scheduler 8A associated with physical upstream channel A will ensure that only one of the two logical upstream channels (labeled A1 and A2) will be transmitting at any instant in time. Thus, at the direction of high-level scheduler 16, the low-level MAP scheduler 8A for physical upstream channel A will dole out burst intervals to each of the cable modems connected to logical upstream channel A1 and logical upstream channel A2. Similarly, either of the low-level schedulers 8B or 8C corresponding to physical channels B and C will dole out bursts to their associated logical channels 1 and 2 when high level scheduler 16 has granted use of the corresponding upstream physical channel.

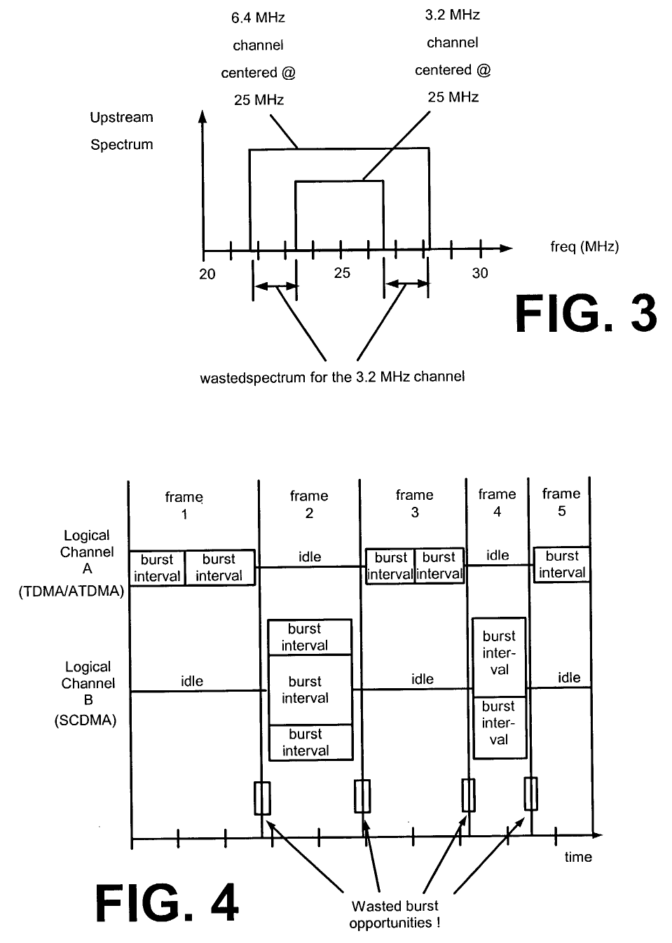

The addition of high-level MAP scheduler 16 to the system can help solve each of the problems discussed in the Background. For example, as discussed, inefficient bandwidth utilization can result from a mix of 6.4 MHz logical upstream channels with 3.2 MHz logical upstream channels (or other low-bandwidth logical upstream channels). This inefficient utilization was shown in FIG. 3. The system shown in FIG. 5 can be used to circumvent this problem, because the system operator can define three different physical upstream channels along a single data path, such as 21A, instead of just defining two logical upstream channels. It will be appreciated that each physical channel will still comprise at least one logical channels so the system will be compatible with the DOCSIS standards, either 1.x or 2.0.

One of the physical upstream channels can be defined to be a 6.4 MHz channel, and the two remaining physical upstream channels can be defined to be 3.2 MHz channels. The center frequencies of the two 3.2 MHz channels can be set so that they each fall in opposite halves of what would be a large 6.4 MHz channel as shown in FIG. 7. Thus, the high-level MAP scheduler 16 of FIG. 5 that controls the time-periods during which each of the physical channels 4 can operate must be cognizant of the fact that the 6.4 MHz channel overlaps the spectra for both of the 3.2 MHz channels, but that the 3.2 MHz channels do not overlap each other's spectra. As a result, the high-level MAP scheduler 16 can intelligently assign time-periods to the low-level MAP schedulers 8A, 8B and 8C associated with the three physical upstream channels A, B and C so that transmissions on the 6.4 MHz physical channel never coincide with transmissions on the either of the two 3.2 MHz physical channels. However, the high-level MAP scheduler can assign time-periods to each of the 3.2 MHz channels that permit simultaneous transmission on each of the 3.2 MHz channels. As a result, there is no wasted bandwidth in the upstream spectrum due to the mix of 6.4 MHz channels for DOCSIS 2.0 and the lower-bandwidth channels for DOCSIS 1.X, as shown in FIG. 3.

The addition of a high-level MAP Scheduler to the system can also help solve the problem associated with switching between the 6.4 MHz mode and the 3.2 MHz mode. As previously discussed, this may result in inefficient burst opportunity utilization from a mix of 6.4 MHz logical upstream channels with 3.2 MHz logical upstream channels (or other low-bandwidth logical upstream channels). This inefficient utilization was shown in FIG. 4. The system shown in FIG. 5 can be used to circumvent this problem, because the system operator can define two different physical upstream channels—instead of defining two logical upstream channels—that are centered on the same center frequency, as shown in FIG. 3.

One of the upstream channels operates with a 6.4 MHz channel, and the other upstream channel operates with a 3.2 MHz channel. The high-level MAP Scheduler ensures that the two different physical upstream channels will not transmit at the same instant in time. Each of the physical upstream channels has a separate PHY receiver associated with it, so the problem of switching receiver modes between the 6.4 MHz channel mode and the 3.2 MHz channel mode is eliminated. The channel bandwidth can effectively be changed instantaneously from 6.4 MHz mode to 3.2 MHz mode by having a PHY receiver configured for 6.$ MHZ transmission stop accepting data and having one or both of the other PHY receivers configured for 3.2 MHz mode begin accepting data at a single instant in time. Although this approach consumes more upstream PHY receiver chips than the approach using the DOCSIS 2.0 logical channels, it may permit cable system operators to mix DOCSIS 2.0 cable modems and DOCSIS 1.X cable modems in the same frequency spectrum even when the DOCSIS 2.0 modems are operating with a 6.4 MHz bandwidth. Since next-generation CMTS blades will likely support more upstream PHY receivers than current CMTS blades, the use of more upstream PHY receivers should not be problematic.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

We claim:

1. A method for efficiently utilizing upstream bandwidth in a communication network along an upstream data path comprising:
receiving upstream data traffic at a node;
assigning the received upstream data traffic to a plurality of physical channels to be transmitted on the upstream data traffic path; and
scheduling the transmission of traffic by the physical channels such that traffic associated with one of the plurality of physical channels is not transmitted simultaneously with traffic associated with another if the bandwidth of either physical channel spectrally overlaps that of the other.

2. The method of claim 1 further comprising steering the upstream spectra collectively used by the plurality of upstream physical channels to a plurality of PHY receivers corresponding to the physical channels.

3. The method of claim 2 further comprising configuring a set of parameters differently for each of the plurality of PHY receivers such that each PHY receiver corresponds to a different one of the plurality of physical channels.

4. The method of claim 3 wherein one of the set of parameters is center frequency.

5. The method of claim 3 wherein one of the set of parameters is channel width.

6. The method of claim 5 wherein the channel width is based on data symbol rate.

7. The method of claim 3 wherein a high-level MAP scheduler directs the PHY corresponding to a scheduled physical channel to receive data and directs the PHYs corresponding to non-scheduled physical channels not to receive data.

8. A system for efficiently transmitting upstream data traffic assigned to a plurality of physical channels at a node in a communication network comprising:
a high level MAP scheduler for scheduling the transmission of traffic by the physical channels such that traffic associated with one of the plurality of physical channels is not transmitted simultaneously with traffic associated with another if the bandwidth of either physical channel spectrally overlaps that of the other.

9. The system of claim 8 further comprising a means for steering the upstream spectra used by the plurality of upstream physical channels to a plurality of PHY receivers corresponding to the physical channels.

10. The system of claim 8 wherein each of a plurality of PHY receivers has at least one of a set of parameters configured differently from each of the other of the plurality of PHY receivers such that each PHY corresponds to a different one of the plurality of physical channels.

11. The system of claim 10 wherein one of the parameters is center frequency.

12. The system of claim 10 wherein one of the parameters is channel width.

13. The system of claim 12 wherein the channel width is based on data symbol rate.

14. The system of claim 10 wherein the high-level MAP scheduler provides control over low-level schedulers, each low-level scheduler being associated with a single physical channel, said control being based on the characteristics of all upstream physical channels requesting transmission, said characteristics being indicated by the configuration of said parameters associated with said physical channel.

15. A system for efficiently transmitting upstream data traffic in a cable modem termination system network from a plurality of cable modems, the traffic being assigned to a plurality of physical channels at a fiber node based on the cable modem protocol being used, comprising:
a plurality of low-level schedulers that control a corresponding plurality of PHY devices;
a high level MAP scheduler for scheduling the plurality of low-level schedulers such that traffic associated with one of the plurality of physical channels is not transmitted simultaneously with traffic associated with another if the bandwidth of either physical channel spectrally overlaps that of the other.

16. The system of claim 15 further comprising a means for splitting data traffic signals at the output of an optical receiver, said traffic signals comprising a plurality of physical channels, such that the same spectral information carrying the plurality of physical channels is provided to each of a plurality of physical channel ports, each physical channel port corresponding to one of the plurality of PHY devices.
